(19) United States
(12) Patent Application Publication
(10) Pub. No.: US 2026/0166973 A1
(43) Pub. Date: Jun. 18, 2026

(54) UTILITY VEHICLE CANOPY CORNER ASSEMBLY

(71) Applicant: Hol Special Parts Pty Ltd, Victoria (AU)

(72) Inventors: Ali Bahrman, Victoria (AU); Masood Aimaq, Victoria (AU)

(73) Assignee: Hol Special Parts Pty Ltd, Victoria (AU)

(21) Appl. No.: 19/388,591

(22) Filed: Nov. 13, 2025

(30) Foreign Application Priority Data
Nov. 13, 2024 (AU) 2024903732

(51) Int. Cl. B60J 7/10

(52) U.S. Cl. CPC B60J 7/102

(57) ABSTRACT

A utility vehicle canopy corner assembly, comprising: a mounting body, comprising at least two interconnected arms configured to receive elongate frame members in receiving slots; the receiving slots, comprising a cavity formed at an end of each of the arms, configured to allow retention of an elongate frame member by fixing means; at least one load spreader, comprising a resilient body, configured to be retained within the cavity of the receiving slots, and configured to distribute the load of an elongate frame member when the elongate frame member is retained in the receiving slot by fixing means.

### BACKGROUND

Utility vehicles, or “utes”, typically comprise a cabin for the driver and one or more passengers and a tub or truck bed mounted to the chassis behind the cabin for carrying and storing loads.

Often tubs are enclosed with a canopy, which protects the contents of the tray from the elements, provides additional storage volume and improved security. Canopies can be factory fitted or retro-fitted to the tray and are available in a range of styles and designs.

The canopies that can be retro-fitted to the trays of utility vehicles are typically designed for the particular marque (make) and model of utility vehicle and therefore are only available in standard sizes. Canopies are typically made from sheets of steel welded together to form the finished canopy.

Alternatively, the canopy is thermoformed from suitable plastics material, such as ABS. Therefore, another problem is that the finished canopies need to be transported from the manufacturing point to the retailer or the customer, which incurs significant transport costs due to the size, shape, and mass of the canopies.

Such canopies may generally moulded or sheet metal fabricated, resulting in complicated and time consuming fabrication.

In the present disclosure, it is desired to provide a utility vehicle canopy corner assembly that addresses or at least ameliorates one or more of the aforementioned problems of the prior art and/or provides a useful commercial alternative.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date.

### SUMMARY

Some embodiments relate to a utility vehicle canopy corner assembly, comprising: a mounting body, comprising at least two interconnected arms configured to receive elongate frame members in receiving slots; the receiving slots, comprising a cavity formed at an end of each of the arms, configured to allow retention of an elongate frame member by fixing means; at least one load spreader, comprising a resilient body, configured to be retained within the cavity of the receiving slots, and configured to distribute the load of an elongate frame member when the elongate frame member is retained in the receiving slot by fixing means.

The receiving slots may further comprise a support rim encircling the receiving slot, configured to extend into an interior of an elongate frame member when received in the receiving slot. The support rim may comprise a crenelated profile. The seal member may comprise at least one interconnected loop structure, configured to match the crenelated profile of the support rim.

The utility vehicle canopy corner assembly may further comprise: a seal member, configured to engage the receiving slot and abut an elongate frame member when retrain in the receiving slot.

The mounting body may comprise a backing member and a removable front plate. The backing member and removable front plate may cooperate to define an internal electronics housing cavity. The mounting body may further comprise at least one support flange, extending between each of the receiving slots, and configured to distribute the load of the received elongate frame members across the assembly. The at least one support flange may further comprise a support pylon at each end, adjacent a receiving slot, and configured to extend into an interior of an elongate frame member when received in the receiving slot. The seal member may further comprise a pylon sealing loop, configured to engage support pylons when the seal is engaged in the receiving slot. The removable front plate may further comprise at least one electronics access aperture.

The at least one load spreader plate may comprise a substantially pentagonal shape.

The at least one load spreader may be removable. The at least one load spreader may be integrally formed as part of the receiving slot.

The seal member may be configured to provide an environmental sealing effect to the receiving slots.

The load spreader may extend through the depth of the seal member, to contact a portion the elongate frame member engaged in the receiving slot, thereby reducing the compression distance of the seal member when the elongate frame member is engaged in the receiving slot.

The reduction in compression distance may be approximately 50% of the seal thickness. The reduction in compression distance is approximately 60% of the seal thickness. The reduction in compression distance may approximately 30% of the seal thickness.

The assembly may further comprise an inner reinforcement plate, configured to engage the mounting body between each receiving slot to provide a reinforcement effect against loading of the elongate frame members when received in the receiving slots.

Some embodiments relate to a utility vehicle canopy corner assembly, comprising: a mounting body, comprising at least two interconnected arms; at least one receiving slot, comprising a cavity formed at an end of an arm, configured to allow retention of an elongate frame member by fixing means; at least one load spreader, configured to be retained in the cavity of the receiving slot, and configured to distribute the load of an elongate frame member when the elongate frame member is retained in the receiving slot.

### BRIEF DESCRIPTION OF DRAWINGS

FIG. 1 depicts a perspective view of a utility vehicle canopy corner assembly according to some embodiments;

FIG. 1A depicts an exploded perspective view of a utility vehicle canopy corner assembly according to some embodiments;

FIG. 2 depicts a front view of a utility vehicle canopy corner assembly backing member according to some embodiments;

FIG. 2A depicts a rear view of a utility vehicle canopy corner assembly backing member according to some embodiments;

FIG. 3 depicts a front view of a utility vehicle canopy corner assembly front plate according to some embodiments;

FIG. 3A depicts a rear view of a utility vehicle canopy corner assembly front plate according to some embodiments;

FIG. 4 depicts a front view of a load spreader according to some embodiments;

FIG. 5 depicts a perspective view of a load spreader received in a receiving slot according to some embodiments;

FIG. 6 depicts a front view of a seal member according to some embodiments;

FIG. 7 is a perspective view of a seal member received on a support rim of a receiving slot according to some embodiments;

FIG. 8 is an exploded perspective view of a receiving slot with seal member and load spreader according to some embodiments;

FIG. 9 is a perspective view of a receiving slot with seal member and load spreader, with a partially transparent elongate arm member received in the receiving slot according to some embodiments;

FIG. 10 is a side sectional view of a receiving slot of a utility vehicle canopy corner assembly according to some embodiments;

FIG. 11 is a perspective transparent view of a utility vehicle canopy corner assembly with electronics components housed therein according to some embodiments;

FIG. 12 is a front view of a backing member of a utility vehicle canopy corner assembly according to some embodiments.

FIG. 13A is a detail view of a utility vehicle canopy corner assembly, according to some embodiments

FIG. 13B is a further detail view of a utility vehicle canopy corner assembly, according to some embodiments; and

FIG. 14 is an assembled view of a utility vehicle canopy, according to some embodiments.

### DETAILED DESCRIPTION

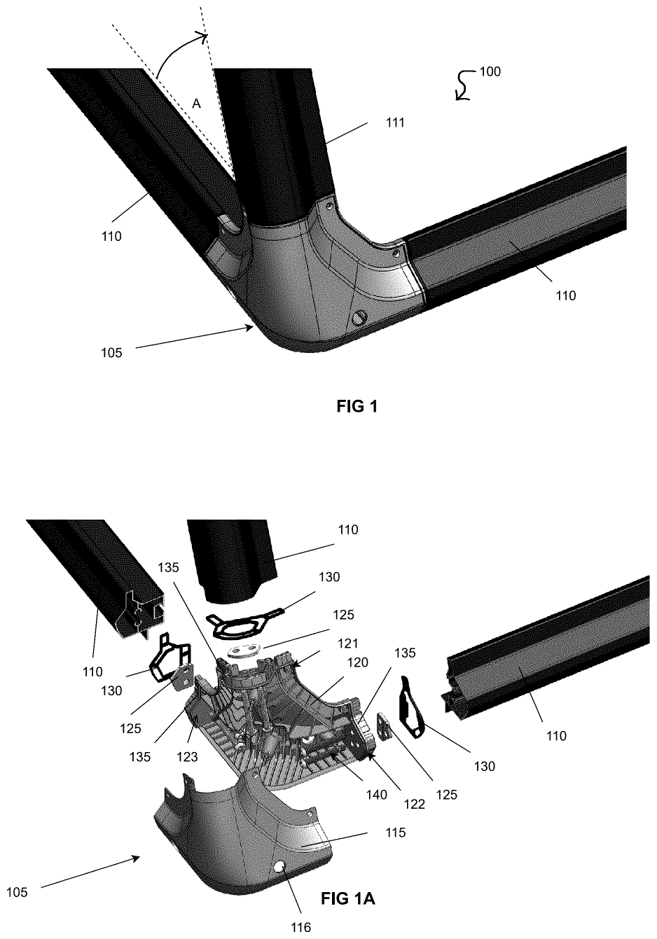

Embodiments generally relate to a utility vehicle canopy corner assembly, and associate components. In the field of the present disclosure, utility vehicle canopies require connecting joints for elongate frame members. In an embodiment of the present disclosure, a canopy corner assembly is provided which provides an improved utility and performance in use. With reference to FIG. 1, a canopy corner 105 is provided. Canopy corner 105 may be a mounting body allowing connection of elongate frame members 110 in a junction formation. In the depicted embodiment, three elongate frame members 110 are provided, two of which in an axially perpendicular arrangement, and a third member 111 disposed at an angle A between zero degrees to 90 degrees with respect to the other members. It may be understood that any appropriate angle may be used to form a rigid and resilient canopy with the corner assembly 105 and the elongate frame members 110. The depicted embodiment in FIG. 1 may be a front canopy corner, with the angle of member 111 allowing the frame member to slope towards a utility vehicle cabin, thereby preserving an angled profile of the vehicle to which it is attached, and, in some embodiments, the angle A may be a drag reducing angle, configured to reduce drag in the wake of the vehicle during transit.

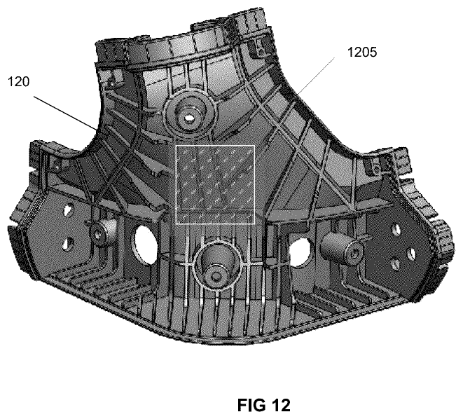

FIG. 1A depicts an exploded perspective view of a utility vehicle canopy corner assembly 105 according to some embodiments. In the depicted embodiment, the canopy corner assembly 105 comprises a backing member 120, with a front plate 115. The front plate 115 may be removably affixable. The front plate 115 may be configured to match the proportions of the backing member 120. The front plate 115 and backing member 120 may cooperate to define an internal cavity 1205, suitable for housing electronics components. This arrangement is shown in greater clarity in FIG. 12. Backing member 120 may comprise three interconnected arms 121, 122, and 123 which are configured to engage elongate frame members 110 and retain them in receiving slots 135. The corner assembly 105 may further comprise at least one load spreader 125. In the depicted embodiment, three load spreaders 125 are provided.

Load spreader/s 125 may be configured to sit within the receiving slots 135, to provide a load distribution effect to fixing means 140 which connect the backing member 120 to the elongate frame members 110. The corner assembly 105 may further comprise at least one sealing member 130, configured to abut the receiving slot 135 and the elongate frame member 110, thereby providing a cushioning effect to the components when installed. Sealing member 130 also acts as an environmental seal, mitigating entrance from water and/or dust into the assembly 105. As depicted in FIG. 1A, front plate 115 may comprise an electronics access aperture 116 to allow for easy installation of electronics components within the internal cavity 1205.

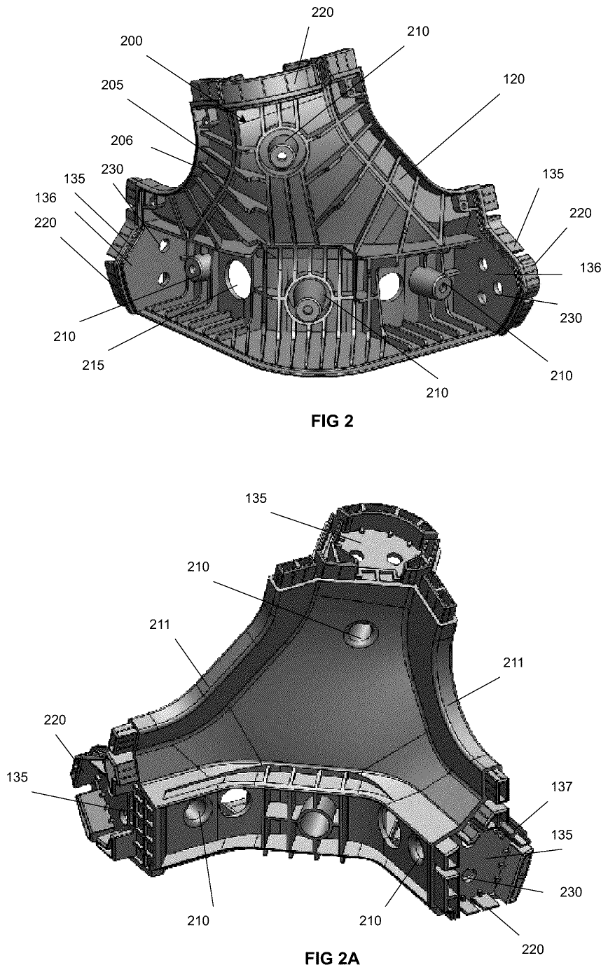

FIG. 2 depicts a front view of a utility vehicle canopy corner assembly backing member 120 according to some embodiments. Backing member 120 may further comprise a plurality of first support struts 205, intersecting at least one second support struts 206 at perpendicular junctions. This arrangement of first support struts 205 and second support struts 206 allows for a space-saving arrangement whereby the rigidity of the canopy corner assembly 105 is maintained, while weight of the part is reduced. This in turn can reduce shipping cost, material usage, and component strain. FIG. 2 also depicts at least one access aperture 215, which may assist in providing access to any stored electronics.

FIG. 2A depicts a rear view of a utility vehicle canopy corner assembling backing member 120. In this view, connection points 210 are displayed, being formed protrusions through the rear side to the front side 115, allowing alignment and interconnection with matched connectors on the front side 115. The backing member 120 may further comprise the receiving slot/s 135. In the embodiment of FIG. 2, three receiving slots are provided. The receiving slots 135 comprise a backing surface 136 with fixing means apertures 230 formed therein, configured to accommodate and bias a screw, bolt, or other fixing means against the surface of the backing member 120.

The receiving slot may be configured to match the sectional profile of elongate frame members 110, to provide a better fit when the members are received in the slot 135. Receiving slot 135 may further comprise a support rim 220 configured to be inserted at least part-way into an elongate frame member 110. Support rim 220 may further comprise a series of crenelations 137, encircling the receiving slot 135 and thereby providing a crenelated profile. The crenelated profile may substantially conform to the cross-sectional profile of an elongate frame member 110. In some embodiments, this comprises a pentagonal profile. A pentagonal profile may allow for better load distribution, and easier assembly, due to the presence of a triangular point on one side acting as an orientational reference, and thereby only engaging the receiving slots 135 to the elongate frame members 110 in one rotational direction.

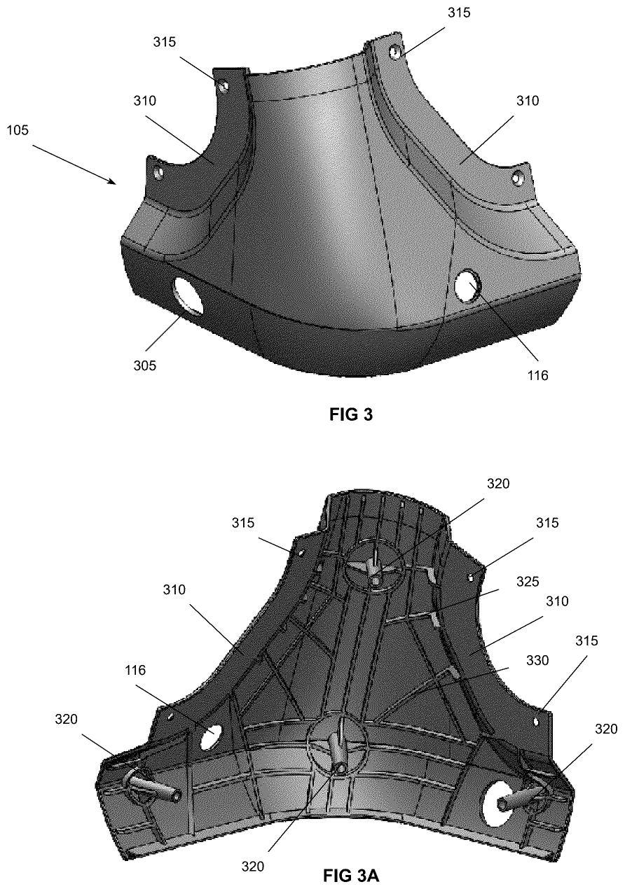

FIG. 3 and FIG. 3A depict a utility vehicle canopy corner assembly front plate 115 according to some embodiments. The front plate 115 may comprise attachment apertures 315 to allow for fixing means to engage the backing member 120 at matched points. Front plate 115 may further comprise fixing pegs 320 to be inserted into matched connection points 210. Front plate 115 may further comprise and arcuate flange portion 310, configured to engage the backing portion and provide improved stability and resilience to forces between adjacent receiving slots 135. The removability of the cover plate 115 allows for access to fixing means to engage the backing member 120 to elongate frame arms 110 via fixing means 140. Subsequently, the front plate 115 may then be attached on to the backing member 120, to provide a sealed and resilient corner unit, reducing access to the engagement points of the elongate frame arms 110 in the receiving slots 135.

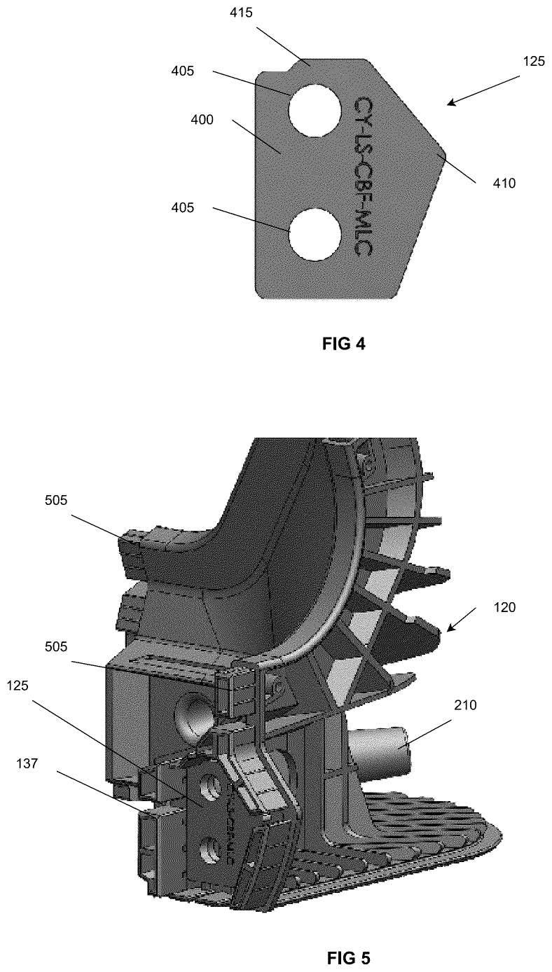

FIG. 4 depicts a front view of a load spreader 125 according to some embodiments. The load spreader 125 may comprise a plate body 400, having fixing apertures 405 formed therethrough. Load spreader 125 may further comprise an orientational flange 415, comprising an extended portion of the plate adjacent a lower portion, and configured to allow for ease of placement in a matched area in a receiving slot 135.

The orientational flange 415 may allow for easier installation of the load spreader 125 by a user, as the plate 125 would thereby only fit in a receiving slot 135 in one orientation. Load spreader 125 may further comprise a pentagonal peak 410, which aids in orientational placement, and provides greater surface area for the load spreader 125. Load spreader 125 reduces the strain of the elongate arm members 110 against the backing member 120 and provides an easily replaceable component that extends the lifespan of the corner assembly 105 as a whole. In corner assemblies that lack a load spreader 125, the forces that ute canopies are subject to during use (including travel strain, and use strain) can strip threads from fixing means 140 or the corner units themselves. Accordingly, the load spreader 125 increases the contact area of the fixing means 140, and resists strain from bending and/or shear forces. It may be appreciated that other shapes of load spreaders 125 may be used, such as square, rectangular, ovaloid, circular, triangular plates, or any combination thereof. Other prismatic forms may be used, depending on the cross-sectional profile of the receiving slots 135 and the elongate frame members 110. Load spreaders 125 may be made from metal, such as aluminium, steel, copper, or other suitable material. In some embodiments load spreaders may be made from plastic, such as laser cut acrylic sheet, or ABS plastic. In some embodiments, load spreader 125 may be integrally formed as part of the receiving slot 135. In such embodiments, the load spreader 125 may comprise a flat surface of the receiving slot 135. Alternatively, the load spreader 125 may comprise a flat raised structure, extending part-way out of the receiving slot 135. In some embodiments, the load spreader 125 may be an embossed feature of the receiving slot 135. In some other embodiments, the load spreader 125 may be a crenelated feature. Other structural variations are envisioned in some embodiments, such as trapezoidal structures, polygonal structures, raised portions, and any other structure capable of distributing load between the elongate arms 120 and the receiving slot 135, that at least part-way extend through a seal member 130.

Accordingly, the load spreader 125 may extend through the depth of the seal member 130, to contact a portion of the elongate member 110 engaged in the receiving slot 135, thereby reducing the compression distance of the seal member when the elongate member 110 is engaged in the receiving slot 130.

FIG. 5 depicts a perspective view of a load spreader 125 received in a receiving slot according to some embodiments. Support pylon 505 is depicted in FIG. 5, adjacent the receiving slot 135, and configured to provide extra support to resist strain from the elongate frame members 110 when received in the receiving slot 135. Support pylon 505 may be integrally formed with the backing member 120. Support pylons 505 may be formed adjacent each receiving slot, at each end of an arcuate backing flange 211. Arcuate backing flanges 211 may provide additional resilience and support to the canopy corner unit 105 as a whole, by resisting strain from engaged elongate frame members 110. Arcuate backing flanges 211 may be configured to engage with arcuate flange portions 310 on the front plate 115.

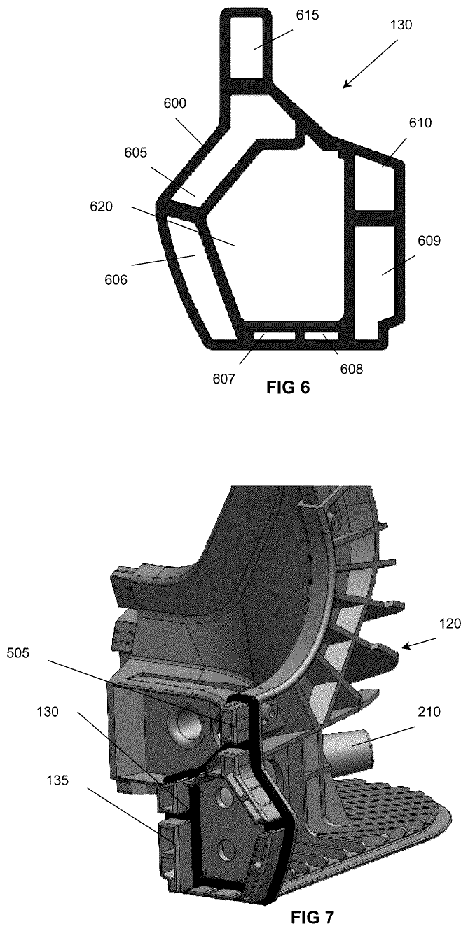

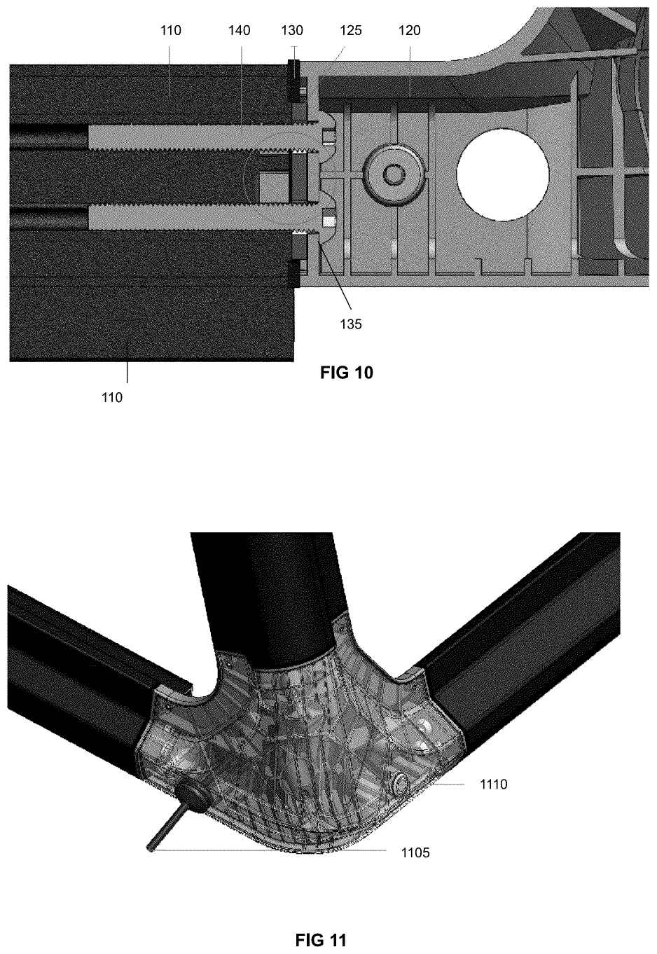

FIG. 6 depicts a front view of a seal member 130 according to some embodiments. Seal member 130 may abut the receiving slot 135 and received elongate frame members 110 when engaged, providing a cushioning and/or sealing effect between these elements. Seal member 130 may comprise a flexible body 600, arranged in a loop formation about a central loop 620. Seal member 130 may comprise at least one interconnected loop structure (605, 606, 607, 608, 609, 610) configured to match the crenelated profile of the support rim 220, such that each crenelation 137 is encircled by a corresponding loop when the seal 130 is engaged with the receiving slot. This provides a cushioning effect to each section of the crenelated profile, and the receiving slot 135 as a whole. FIG. 7 is a perspective view of the seal member 130 received on a support rim of a receiving slot according to some embodiments. Seal member 130 may further provide an environmental sealing effect, reducing entrance of dust and water, to the joint between the receiving slot 135 and elongate arm 110. Seal member 130 may further comprise a support pylon loop, adjacent the central loop 620, and configured to engage the support pylon 505 to provide a cushioning and/or sealing effect. The cushioning effect reduces wear-and-tear between the elongate frame members 110 and the receiving slot 135, extending the lifespan of each of these components. Furthermore, as depicted in FIG. 10, when the seal 130 contacts the elongate arm 110 and the receiving slot 135, the load spreader 125 may contact the elongate arm 110 to prevent over compression of the seal 130. Load spreader 125 may extend approximately half-way through the depth of the seal 130, thereby reducing the amount of compression by approximately 50%. In other embodiments, the load spreader 125 may be configured to allow compression of the seal by approximately 60%. In still other embodiments, the load spreader 125 may be configured to allow compression of the seal by approximately 30%. In some embodiments, the load spreader may allow compression of the seal 130 by 50% or less. In some embodiments. The reduction in compression distance of the seal 130 has the benefit of extending the lifespan of the seal, and reducing potential damage by over tightening to both of the elongate arm 110 and the receiving slot 135. In some embodiments, the load spreader 135 may be proportioned to extend at a distance 1 mm lower than the seal member 130 when placed in the receiving slot 135.

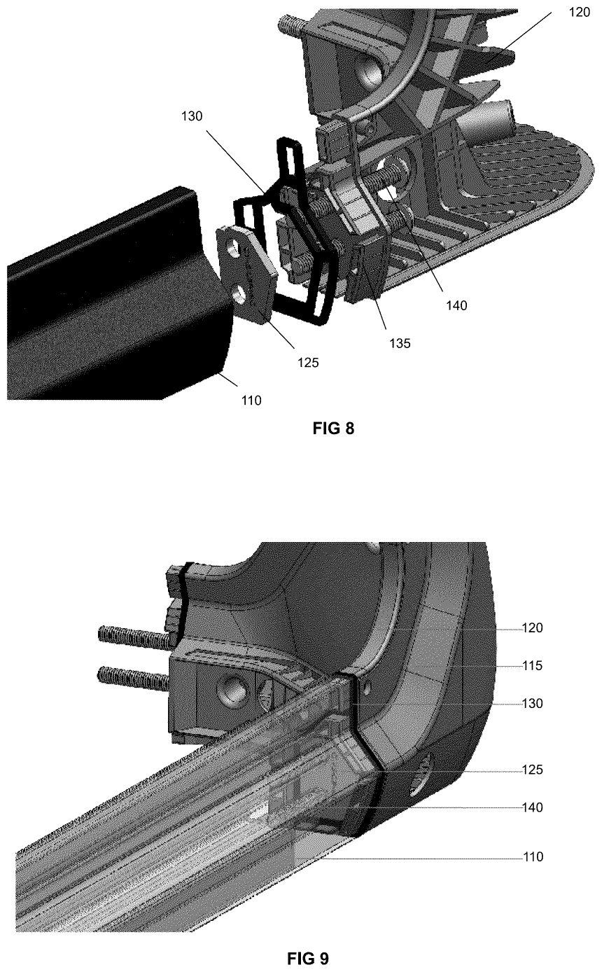

FIG. 8 is an exploded perspective view of a receiving slot 135 with seal member and load spreader according to some embodiments. FIG. 9 is a perspective view of a receiving slot with seal member and load spreader, with a partially transparent elongate arm member received in the receiving slot according to some embodiments. In this view, the components which are displayed in FIG. 8, namely the elongate frame member 110, load spreader 125, seal member 130, receiving slot 135, and fixing means 140, are then assembled together in the view of FIG. 9, displaying the canopy corner assembly 105 in use.

FIG. 10 is a side sectional view of a receiving slot of a utility vehicle canopy corner assembly 105 according to some embodiments. Accordingly, this view displays the cushioning effect of the seal member 130, as it abuts the receiving slot 135 and the elongate frame member 110, being compressed therebetween by the force of the fixing means 140 connecting these components. Furthermore, load spreader 125 further provides a load distribution effect, by engaging the fixing means 140 and acting as a replaceable thicker joint connection.

FIG. 11 is a perspective transparent view of a utility vehicle canopy corner assembly 105 with electronics components housed therein according to some embodiments. In this embodiment, electronics wiring 1105 is provided through the electronics aperture 305 in the front plate 115. Button 1110 may be provided to allow for operation of the housed electrical components.

FIG. 12 is a front view of a backing member of a utility vehicle canopy corner assembly according to some embodiments, displaying an electronics housing cavity 1205, formed in the backing member 120, by the arrangement of first support struts 205 and second support struts 206.

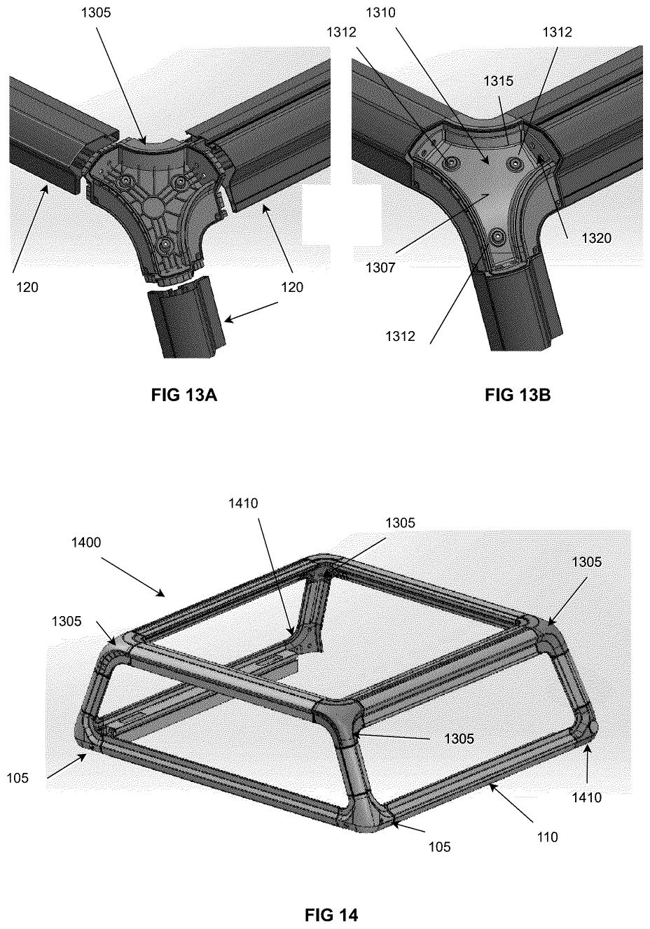

FIG. 13A and FIG. 13B depict an upper canopy corner 1305, with backing plate removed. In the depicted embodiment, the assembly further comprises an inner reinforcement plate 1310. Inner reinforcement plate 1310 is configured to add further structural stability to the canopy corner 1310. inner reinforcement plate 1310 may comprise a surface 1307. Inner reinforcement plate 1310 may further comprise a peripheral reinforcement rim 1315 configured to abut the edges of the assembly. Surface 1307 may comprise apertures 1320 configured to allow entrance of fixing means through the Inner reinforcement plate 1310, thereby affixing the inner reinforcement plate 1310 with the elongate members 120 when the corner is assembled. Inner reinforcement plate 1310 may further comprise apertures 1312, configured to match the apertures on the backing member 120. Accordingly, the assembly may further comprise an inner reinforcement plate, configured to engage the mounting body between each receiving slot to provide a reinforcement effect against loading of the elongate frame members when received in the receiving slots.

FIG. 14 depicts an assembled ute canopy frame 1400. In the depicted embodiment, the canopy 1400 comprises four upper canopy corners 1305, two front lower canopy corners 105, and two rear lower canopy corners 1410. Each of the canopy corners connected to at least two elongate members 110. The upper canopy corners 1305 and lower front canopy corners 105 comprise three interconnected arms capable of engaging elongate members 110. Lower rear canopy corners 1410 comprise two interconnected arms capable of engaging elongate members 110. Accordingly, the canopy corner members may comprise at least two interconnected arms. In some embodiments, the canopy corners may be configured to connect more than three elongate members 110. Lower rear canopy corners 1410 may only have receiving slots 135 for two elongate members 110 in order to allow for a moveable ute tail gate to be deployed in the space therebetween.

Accordingly, a useful utility vehicle canopy corner assembly is provided, having improved resilience and utility when compared to the existing state of the art.

1. A utility vehicle canopy corner assembly, comprising:
a mounting body, comprising at least two interconnected arms configured to receive elongate frame members in receiving slots;
the receiving slots, comprising a cavity formed at an end of each of the arms, configured to allow retention of an elongate frame member by fixing means;
at least one load spreader, comprising a resilient body, configured to be retained within the cavity of the receiving slots, and configured to distribute the load of an elongate frame member when the elongate frame member is retained in the receiving slot by fixing means.

2. The assembly of claim 1, wherein the receiving slots further comprise a support rim encircling the receiving slot, configured to extend into an interior of an elongate frame member when received in the receiving slot.

3. The assembly of claim 2, wherein the support rim comprises a crenelated profile.

4. The assembly of claim 3, wherein the utility vehicle canopy corner assembly further comprises: a seal member, configured to engage the receiving slot and abut an elongate frame member when retained in the receiving slot and, optionallywherein the seal member comprises at least one interconnected loop structure, configured to match the crenelated profile of the support rim.

5. The assembly of claim 1, wherein the mounting body comprises a backing member and a removable front plate.

6. The assembly of claim 5, wherein the backing member and removable front plate cooperate to define an internal electronics housing cavity.

7. The assembly of claim 1, wherein the mounting body further comprises at least one support flange, extending between each of the receiving slots, and configured to distribute the load of the received elongate frame members across the assembly.

8. The assembly of claim 7, wherein the at least one support flange further comprises a support pylon at each end, adjacent a receiving slot, and configured to extend into an interior of an elongate frame member when received in the receiving slot.

9. The assembly of claim 8, when dependent on claim 4, wherein the seal member further comprises a pylon sealing loop, configured to engage support pylons when the seal is engaged in the receiving slot.

10. The assembly of claim 6, wherein the removable front plate further comprises at least one electronics access aperture.

11. The assembly of claim 1, wherein the at least one load spreader comprises a substantially pentagonal shape.

12. The assembly of claim 1, wherein the at least one load spreader is removable.

13. The assembly of claim 1, wherein the at least one load spreader is integrally formed as part of the receiving slot.

14. The assembly of claim 4, wherein the seal member is configured to provide an environmental sealing effect to the receiving slots.

15. The assembly of claim 4, wherein the load spreader extends through the depth of the seal member, to contact a portion of the elongate member engaged in the receiving slot, thereby reducing the compression distance of the seal member when the elongate member is engaged in the receiving slot.

16. The assembly of claim 15, wherein the reduction in compression distance is approximately 50% of the seal thickness.

17. The assembly of claim 15, wherein the reduction in compression distance is approximately 60% of the seal thickness.

18. The assembly of claim 15, wherein the reduction in compression distance is approximately 30% of the seal thickness.

19. The assembly of claim 1, wherein the assembly further comprises an inner reinforcement plate, configured to engage the mounting body between each receiving slot to provide a reinforcement effect against loading of the elongate frame members when received in the receiving slots.

20. A utility vehicle canopy corner assembly, comprising:
a mounting body, comprising at least two interconnected arms;
at least one receiving slot, comprising a cavity formed at an end of an arm, configured to allow retention of an elongate frame member by fixing means;
at least one load spreader, configured to be retained in the cavity of the receiving slot, and configured to distribute the load of an elongate frame member when the elongate frame member is retained in the receiving slot.
